(19) United States
(12) Patent Application Publication
(10) Pub. No.: US 2025/0101936 A1
(43) Pub. Date: Mar. 27, 2025

(54) FUEL FITTING

(71) Applicant: Holley Performance Products, Inc., Bowling Green, KY (US)

(72) Inventor: Junnior C. Rodriguez, Bowling Green, KY (US)

(21) Appl. No.: 18/896,175

(22) Filed: Sep. 25, 2024

Related U.S. Application Data
(60) Provisional application No. 63/585,761, filed on Sep. 27, 2023.

(51) Int. Cl. F02M 37/00; F02M 55/00

(52) U.S. Cl. CPC F02M 37/0052; F02M 55/004

(57) ABSTRACT

Present embodiments relate to a fitting. More specifically, but without limitation, present embodiments relate to a fuel fitting, which may be used with existing fuel tanks that require a non-welded connection. The use of this fuel fitting allows for retro-fit of a used fuel tank into a system with a return fuel line.

### PRIORITY/INCORPORATION BY REFERENCE

Any and all applications for which a foreign or domestic priority claim is identified in the Application Data Sheet as filed with the present application are hereby incorporated by reference herein and made a part of the present disclosure.

### BACKGROUND

### 1. Field of the Invention

Present embodiments relate to a fitting. More specifically, but without limitation, present embodiments relate to a fuel fitting, which may be used with existing fuel tanks that require a non-welded connection.

### 2. Description of the Related Art

Fuel systems sometimes utilize a return fuel line from the engine to the fuel tank. When the fuel system is fully pressurized, the return line allows for return fuel from the engine to the fuel tank. This construction is relatively easy with new fuel tanks and/or new constructions, because welding a fitting on a new fuel tank which has not contained flammable fuel poses little danger, beyond normal welding issues.

However, many vehicle builds involves use of at least some existing parts, which in some instances involves an existing, used fuel tank. Therefore welding such is dangerous and modification on a non-fuel return system to a fuel return system is problematic.

The information included in this Background section of the specification, including any references cited herein and any description or discussion thereof, is included for technical reference purposes only and is not to be regarded subject matter by which the scope of the invention is to be bound.

### SUMMARY

The present application discloses one or more of the features recited in the appended claims and/or the following features which alone or in any combination, may comprise patentable subject matter.

The present embodiments provide a fuel fitting for use where welding is difficult, dangerous, or otherwise undesirable, and therefore allows for a weldless installation. The weldless fitting allows for installation of the fitting in a fuel tank which has previously contained fuel and therefore may not be suited for welding. The fitting thereby also may preclude the need to buy a new fuel tank when modification requires a return fuel line. The weldless fitting deforms during installation to capture the fitting once a portion of the fitting passes through a hole in the fuel tank. A return line is connected to one portion of the fitting and a conduit from the fitting into the fuel tank, for example a lower portion of the fuel tank, may be connected.

According to some embodiments, a weldless fuel fitting comprises a head having a plurality of surfaces and two intersecting fluid flow paths therein, a first surface of the plurality of surfaces having a first aperture which extends into the head and defines one flow path of the two intersecting fluid flow paths, a second aperture disposed a second surface of the head, a second flow path of the two intersecting fluid flow paths disposed within the head. A stem extends from the head and is in fluid communication with the second flow path. The stem has a shank that is deformable upon fastening of a fastener therein, wherein the shank deforms upon tightening by the fastener and configured to engage a fuel tank without requiring a weld.

In some embodiments, the weldless fuel fitting may further comprise at least one thread within the first aperture.

In some embodiments, the weldless fuel fitting may further comprise at least one second thread in the second aperture.

In some embodiments, the at least one second thread may be configured to allow for rotational engagement of the head to tighten the fastener within the fuel tank during installation.

In some embodiments, when the fastener is tightened relative to the head, the shank deforms to seal the weldless fuel fitting to the fuel tank.

In some embodiments, the at least one thread may receive one of a fuel fitting, fuel line, or fuel conduit.

In some embodiments, the at least one second thread may be configured to receive a threaded plug when the weldless fuel fitting is installed in the head.

In some embodiments, the weldless fuel fitting may further comprise knurling on an exterior of the shank.

In some embodiments, the stem may further comprise one or more retaining features for engagement of a fuel line.

In some embodiments, the one or more retaining features may be disposed on the stem at an end of the shank distal from the head.

In some embodiments, flow paths may comprise two or more flow paths.

According to some embodiments, a method of retro-fitting a fuel tank for a return fuel line comprises the steps of: drilling a hole in the fuel tank, installing a fitting through the hole, the fitting comprising: a head having a plurality of surfaces and two intersecting fluid flow paths therein, a first surface of the plurality of surfaces having an aperture which extends into the head and defines one flow path of the two intersecting fluid flow paths, a second aperture disposed a second surface of the head, a second flow path of the two intersecting fluid flow paths disposed within the head, a stem extending from the head and in fluid communication with the second flow path, the stem having a shank that is deformable upon fastening of a fastener therein; fastening the fastener in the stem within the fuel tank, and, deforming the shank by tightening of the fastener along an interior surface of the fuel tank to seal the fitting to the fuel tank.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

In order that the embodiments may be better understood, embodiments of a fuel fitting will now be described by way of examples. These embodiments are not to limit the scope of the claims as other embodiments of a fuel fitting will become apparent to one having ordinary skill in the art upon reading the instant description. Non-limiting examples of the present embodiments are shown in figures wherein:

FIG. 1 is a schematic view of vehicle engine throttle body with a fuel return system;

FIG. 2 is a first perspective view of an embodiment of a weldless fuel fitting;

FIG. 3 is a second perspective view of the weldless fuel fitting of FIG. 2;

FIG. 4 is a section view of the weldless fuel fitting;

FIG. 5 is a partial section perspective view of the fitting after the deformed portion is formed;

FIG. 6 is flow chart depicting a method of installing the weldless fitting;

FIG. 7 is an upper perspective view of a weldless fuel fitting located at a surface of a fuel tank; and,

FIG. 8 is a perspective view of the opposite surface of the fuel tank from FIG. 7, with a fuel conduit extending from the fitting.

### DETAILED DESCRIPTION

It is to be understood that a fuel fitting is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

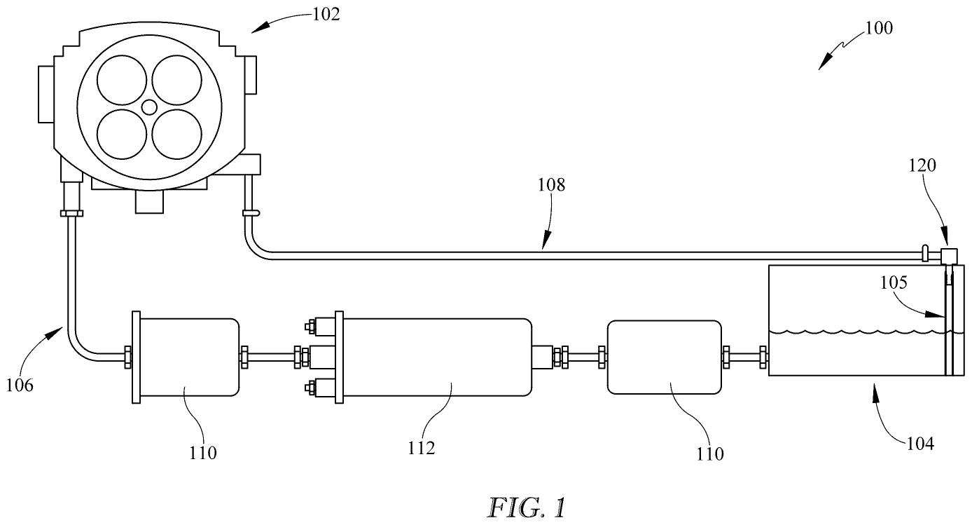

Referring now to FIGS. 1-8, wherein a fuel system and method are provided which utilize a weldless fitting, for example a fuel fitting. The weldless fitting allows for use or re-configuration of a fuel system having a used tank, or where welding is not possible, to a fuel return system. The weldless fitting may be positioned through a hole in a fuel tank and includes a shank having a stem that is deformable. During installation, the deformable portion crushes into a condition that seals the hole in the tank.

Referring first to FIG. 1, a schematic view of an example embodiment of a fuel return system 100 is depicted. The fuel return system 100 provides a throttle body assembly 102 which is located at, and generally representative of, a vehicle engine (not shown). The throttle body assembly 102 meters fuel delivery to the engine as well as mixing air with the fuel for delivery to an ignition source within the engine. In some configurations the throttle body assembly 102 may be an electronic throttle body with fuel injectors that direct fuel to an air flow moving through the throttle body.

The schematic view also depicts a fuel tank 104 which has one fuel line 106 that directs fuel from the fuel tank 104 to the throttle body 102 and a second line 108 that returns fuel from the throttle body to the fuel tank. The fuel supply line 106, defined as supplying fuel to the throttle body, may comprise one or more fuel filters 110 and a pump 112. The one or more fuel filters 110 may each include a filter of a first size and a filter of a second size, for example.

The return line 108, defined as returning fuel from the throttle body 102 to the fuel tank 104. The return line 108 is shown in communication with a fitting 120 at the fuel tank 104. As noted previously, some fuel systems do not have a return line configuration. In these types of systems, where it may be desirable to convert to such return line configuration, the welding of a fitting to a fuel tank which has been in service is a potential explosive hazard. An alternative manner of connecting a fitting 120 to such tank becomes a necessity, and even where a fuel tank 104 is new, not all engine builders have access to welding equipment so a manner of connecting such fitting is desirable without the need for welding equipment and expertise.

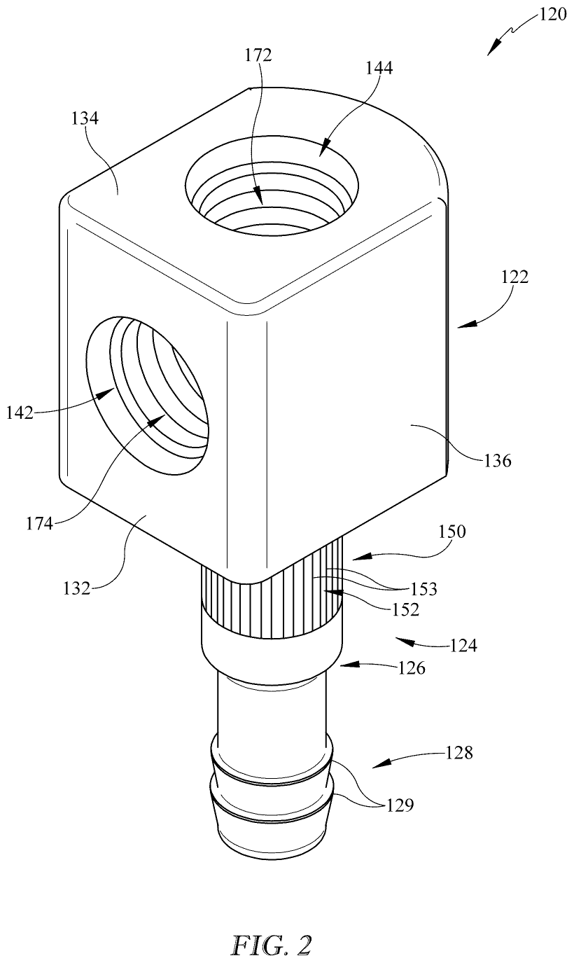

Referring now to FIG. 2, a perspective view of the weldless fitting 120 is shown and provided. The weldless fitting 120 may be used where an installer does not have access to both sides, inside and outside for example, of the fuel tank 104. The weldless fitting 120 may be machined from of a billet material, for example billet aluminum, and may be used in some configurations on steel or aluminum fuel tanks 104. This material list however is not exhaustive as other materials may be utilized.

The fitting 120 comprises a head 122 and a shank 124 depending from the head. The shank 124 includes a stem 126 and one or more retaining features 128, such as barbs 129 without limitation. The fitting 120 is placed in part through a hole in the fuel tank 104 so that the head 122 is positioned outside the fuel tank 104 and the shank 124 extends through the tank wall and into the tank.

The head 122 may be formed of various shapes and may comprise two or more surfaces 132, 134. Each of two of the surfaces 132, 134 may comprise an aperture, for example first aperture 142 and second aperture 144, and each aperture 142, 144 may further include threads or other retention/connection features 172, 174 therein. The apertures 142, 144 provide locations for positioning of fuel conduits, retaining features, plugs, fastening devices, or the like. To be clear, while threads 172, 174 are shown and described, other features may be used for retention/connection of conduits, retaining features, plugs, and the like may be utilized. The head 122 may further comprise one or more additional surfaces 136, 138.

The one or more apertures may comprise a first aperture 142 on a front surface of the head 122. The term front is merely descriptive of one side, for purpose of clarity of description, but should otherwise not be considered limiting. The first aperture 142 may be various sizes depending on the desired connection. In some embodiments, the aperture 142 may be used for an adapter fitting which may be, without limitation, 6AN, 8AN, 5/16″ or ⅜″ hose barb. The first aperture 142 may be used for connection of a fuel return line 108 to the fuel tank 104. Thus return fuel from the engine, for example throttle body 102, may pass through the aperture 142, through the fitting head 122 and to the fuel tank 104.

A second aperture 144 of the one or more apertures is located on the surface 134 of the head 122. The aperture 144 may be threaded and extend through the head 122 from the upper surface 134 to the shank 124. The second aperture 144 provides a location for positioning of a bolt to create the retention of the fitting to the fuel tank. Once this occurs, a plug may be threadably positioned in the aperture 144 of the opening so that the second aperture 144 is closed from any fuel flowing through the weldless fitting.

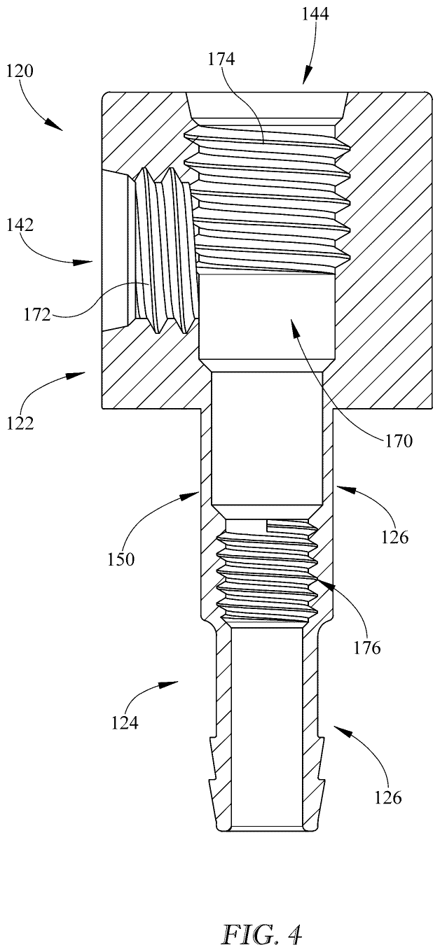

The first aperture 142 and the second aperture 144 each define fluid flow paths through the head 122. The head 122 comprises an internal cavity 170 (FIG. 4) wherein the flow path extending from the first aperture 142 and the flow path extending from the second aperture 144 intersect. An additional flow path is formed through the shank 124 so that fluid flow from within the head 122 moves through the shanks 124. While there are shown two flow paths corresponding to the first aperture 142, and the second aperture 144, there may be additional flow paths by forming additional openings in the head 122.

Beneath the head 122 of the fitting 120 is the shank 124. The shank 124 may comprise a stem 126 having deformable portion 150 and one or more retaining feature 128 for connection of a fuel conduit. The shank 124 extends through the surface of the fuel tank 104 and into the interior of the tank. Once positioned through the hole in the tank 104, the fitting 120 may be permanently connected and sealed to the tank. In operation, as part of the fuel return process, the return line 108 is connected to the first aperture 142 and the fuel moves through the fitting 120 downwardly into the fuel tank 104.

The deformable portion 150 of the shank 124 may comprise a knurling 152 on the exterior surface to improve engagement between the shank 124 and the fuel tank 104. A fastener (not shown) may be threadably positioned into the second aperture 144. During such installation, it may be desirable to preclude spinning of the fitting 120 relative to the the fuel tank 104. The knurling 152 may create a frictional engagement with the fuel tank 104 which precludes such spinning. The knurling 152 is shown as a plurality of ribs 153, extending in the axial direction of the shank 124, however other surface treatments may be utilized to cause engagement with the fuel tank and limit rotation of the fitting relative to the fuel tank.

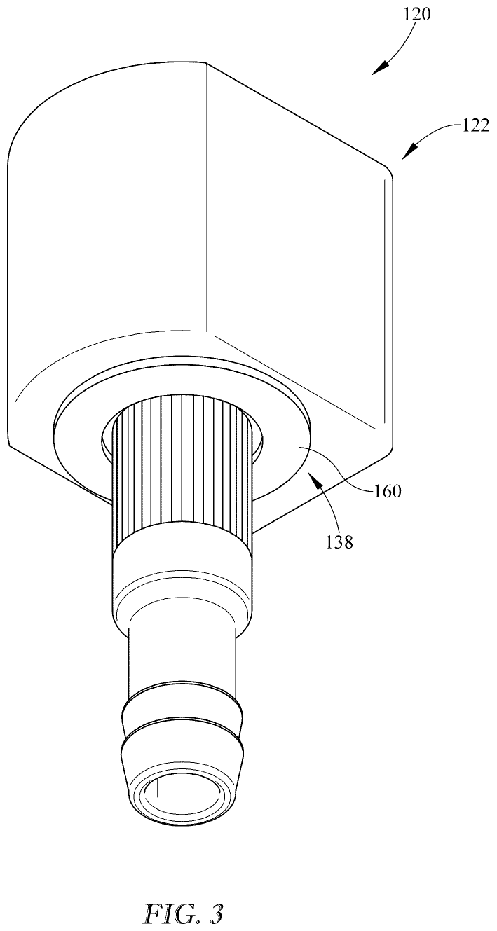

Referring now to FIG. 3, a lower perspective view of the weldless fitting 120 is shown. The fitting 120 is shown with a washer 160 disposed on the bottom surface 138 thereof. The washer 160 may be elastomeric material, for example formed of rubber or Viton fluoroelastomer sealing washer, for example a 75A durometer material. These are non-limiting examples and other materials with differing characteristics may be utilized. The washer 160 provides a sealing material between the bottom 138 of the head 122 and the fuel tank 104.

Referring now to FIG. 4, a section view of the weldless fitting 120 is shown. In the section view, the first aperture 142 is shown having an internal thread 172 and the second aperture 144 is shown having a second internal thread 174. Both the first aperture and the second aperture 142, 144 are in fluid communication with a common internal cavity 170 within the head 122. The internal cavity 170 is also in fluid communication with the shank 124. Through this view, it is shown that the first and second apertures 142, 144, the internal cavity 170, and the internal area of the shank 124 are all in fluid communication. As previously described, the return fuel moves through the first aperture 142 and the through the hollow interior of the shank 124.

Additionally shown in the hollow interior of the shank 124 is a threaded area 176. The threaded area 176 is disposed below the deformable portion 150 and is engaged by a fastener that is inserted through the aperture 144. The fastener extends past threads 174 without engaging and then engages threaded area 176. The deformable portion 150 may axially contract to deform when the fitting 120 is fastened to the fuel tank 104. As shown in the cross-sectional view, the walls of the deformable portion 150 are thin as compared to other portions so that the thinned deformable portion 150 is the weak area that deforms when a fastener engages the threaded area 176.

As shown the figure, the second aperture 144 is aligned axially with the shank 124. The second aperture 144 receives a fastener which extends into the shank and engages the internal thread therein. The thread 176 in the shank 124 is engaged by the fastener. When the fastener is rotated, and the fitting 120 is retained in position, the shank 124 is pulled toward the head 122. As this occurs, the deformable portion mushrooms in deformation and in some embodiments may expand radially outwardly while shortening in the axial direction. With the bulging of the deformable portion 150 and the larger size of the head 122, the fuel tank is captured between. Additionally, the washer 160 along the bottom surface 138 of the head 122 seals the head 122 to the upper surface of the fuel tank 104 and against any inadvertent leakage of fuel from within the tank 104 and around the head 122.

In this section view, one skilled in the art will also realize that the threaded aperture 144 is of a larger diameter than the threaded portion 176. In this way a fastener sized to fit the threaded portion 176 passes through the aperture 144 without engaging the coaxial threads 174 of the aperture 144. This allows for the installation of the fitting without the welding process and steps.

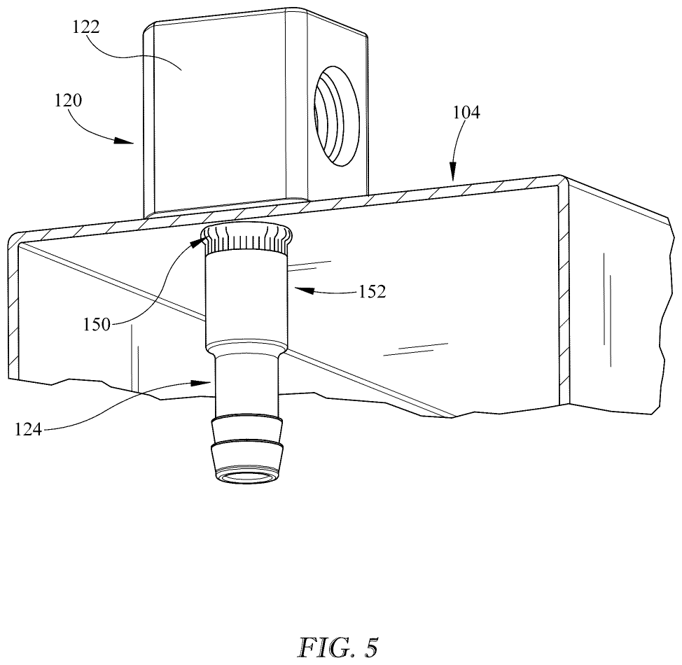

Referring now to FIG. 5, a perspective view of the fitting 120 is shown. The fitting 120 is shown in the deformed configuration such that the deformed portion 150 of the shank 124 is expanded radially. In this mushroom-like shape, the deformed portion 150 has an outer diameter that is larger than the hole in the fuel tank 104 on the inside of the fuel tank 104. This precludes movement in the one axial direction while the fitting head 122 precludes movement in a second opposite axial direction. The fuel tank 104 is shown captured between the two larger sizes of the head 122 and the deformed portion 150. Also, the washer 160 (FIG. 3) is disposed between the outer surface of the tank 104 and the head 122.

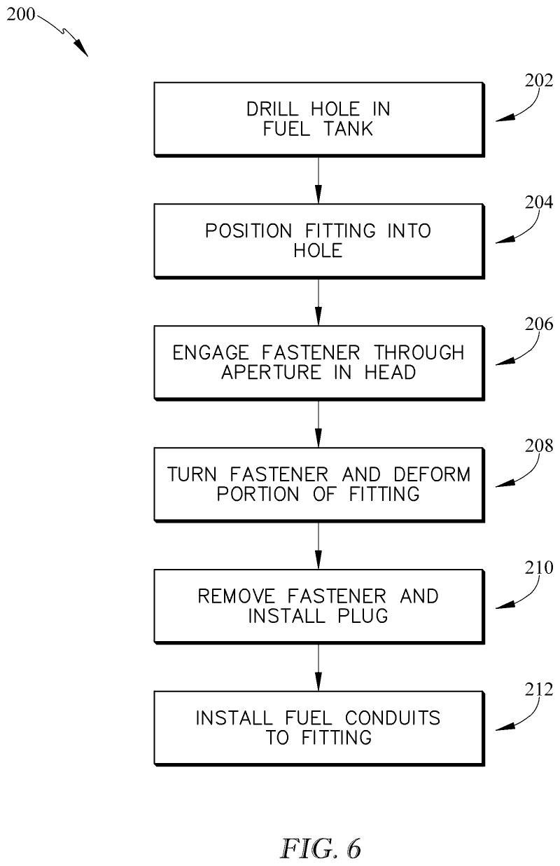

Referring now to FIG. 6, a method 200 of installation is described in a flow chart form. The method of installation comprises the step 202 of drilling a hole in a fuel tank 104. This may be done by drill or other hole forming tool and in some embodiments is placed in a horizontal surface of the tank, for example an upper horizontal surface. A pre-existing hole may also be utilized. In a next step 204, the fitting 120 is installed through the hole. This may occur by placing the shank 124 downwardly through the hole. The sealing washer 160 may be placed on the shank 124 before placing the fitting through the hole, and the fitting is positioned with the head 122 and the washer 160 disposed against the surface of the fuel tank 104. Once the fitting is placed through the hole in the fuel tank, in a next step 206 a fastener is placed through the second aperture 144 in the fitting head. The fastener extends into the shank 124 and is threadably affixed to internal threads 176 therein. In a subsequent step 208, the fastener may be tightened by a wrench, for example an impact wrench, to provide high rotational torque and provide consistent collapse of the deformed portion 150. Once the internal shank threads 176 are engaged, the fitting head 122 may turn with the fastener. However, the knurling 152 on the shank 124 precludes rotation of the fitting 120 such that the deformable portion begins to deform and radially expand.

Once the fitting 120 captures the fuel tank 104 surface between the head 122 and the deformed portion 150 of the shank 124, the fastener may be removed from the second aperture at step 210, and a plug threadably positioned in the second aperture.

Additionally, a conduit may be connected directly or indirectly, such as by an intermediate fitting, to the first aperture at step 212. This conduit provides return fuel to the fitting 120. The fuel passes through the first aperture 142, through the head 122, and downwardly through the shank into the fuel tank.

Finally, a second fuel conduit 108 may be positioned on the retaining structure(s) 129 (FIG. 2) of the shank 124. For example, the conduit may be a flexible material suitable for use with fuel or other chemical. The conduit 105 may be positioned over the barbs and extend to the bottom of the fuel tank 104 or near the bottom. The engagement may be by way of interference fit, friction fit, or hose clamp, for non-limiting example. Alternatively, the retaining structures may provide a threaded engagement for a conduit. The conduit may also include a weight or other outlet structure to stabilize the conduit.

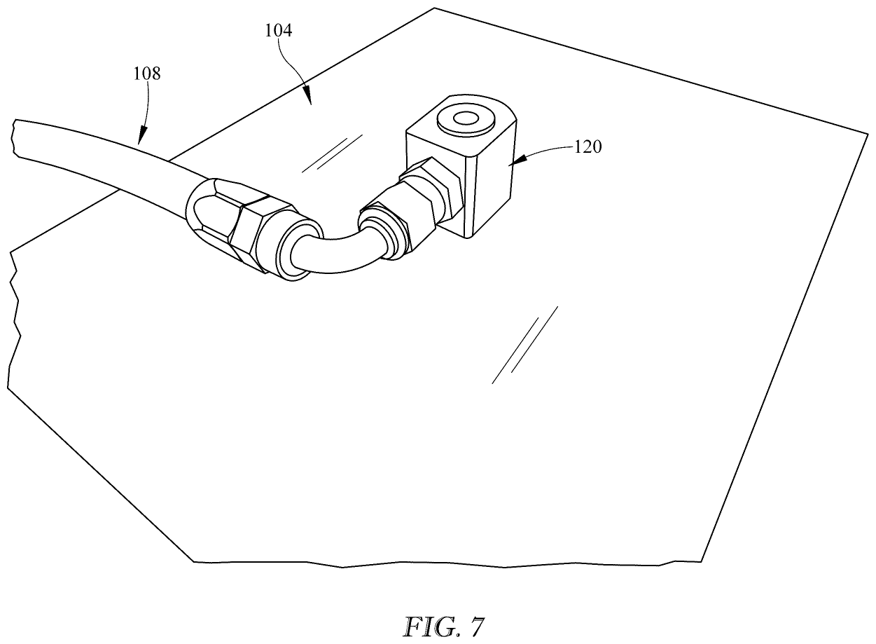

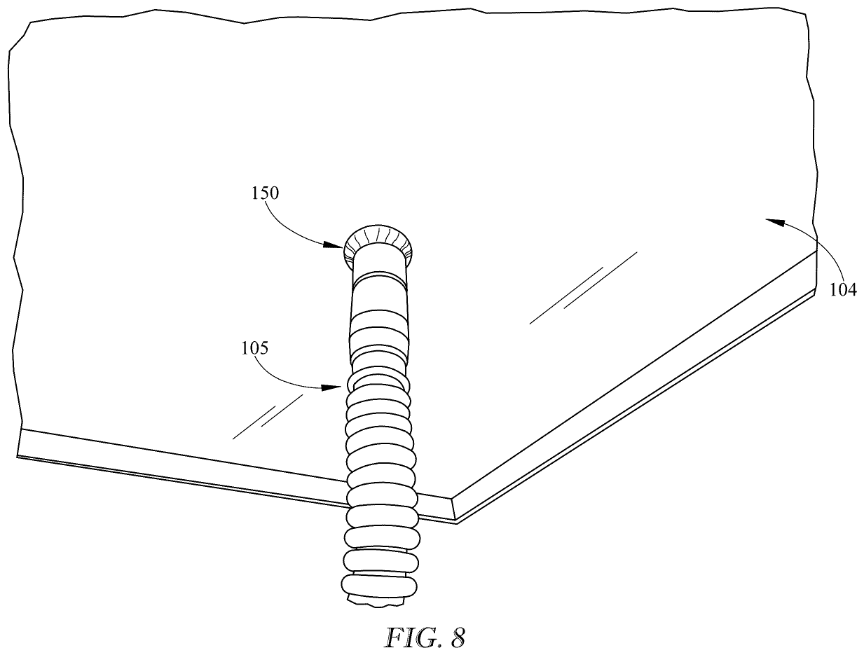

With reference now to FIGS. 7 and 8, the weldless fitting 120 is shown installed in a portion of the fuel tank 104. In the view shown in FIG. 7, the fitting 120 is on an upper surface of the fuel tank 104. The fuel line 108 is shown extending from the fitting and is connected by an elbow connection, although others may be utilized.

Further however, with additional regard to FIG. 8, the fitting 120 is shown extending through the fuel tank 104. The view is from below and within the fuel tank 104. The deformable portion 150 is positioned against an interior surface of the fuel tank 104. The head 122 is positioned on the exterior, opposite side of the tank 104 from the deformable portion 150. Therefore, the surface of the fuel tank 104 is captured between the head 122 and the deformable portion 150. The fuel conduit 105 is shown extending into the fuel tank 104 from the fitting 120. The

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B or C as well as any combination thereof.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A weldless fuel fitting, comprising:
a head having a plurality of surfaces and two intersecting fluid flow paths therein;
a first surface of said plurality of surfaces having a first aperture which extends into said head and defines one flow path of said two intersecting fluid flow paths;
a second aperture disposed a second surface of said head;
a second flow path of said two intersecting fluid flow paths disposed within said head;
a stem extending from said head and in fluid communication with said second flow path;
said stem having a shank that is deformable upon fastening of a fastener therein, wherein said shank deforms upon tightening by said fastener and configured to engage a fuel tank without requiring a weld.

2. The weldless fuel fitting of claim 1, further comprising at least one thread within said first aperture.

3. The weldless fuel fitting of claim 2, further comprising at least one second thread in said second aperture.

4. The weldless fuel fitting of claim 3, said at least one second thread configured to allow for rotational engagement of said head to tighten said fastener within said fuel tank during installation.

5. The weldless fuel fitting of claim 2, wherein when said fastener is tightened relative to said head, said shank deforms to seal said weldless fuel fitting to said fuel tank.

6. The weldless fuel fitting of claim 3, said at least one thread receiving one of a fuel fitting, fuel line, or fuel conduit.

7. The weldless fuel fitting of claim 6, said at least one second thread configured to receive a threaded plug when said weldless fuel fitting is installed in said head.

8. The weldless fuel fitting of claim 1, further comprising knurling on an exterior of said shank.

9. The weldless fuel fitting of claim 1, said stem further comprising one or more retaining features for engagement of a fuel line.

10. The weldless fuel fitting of claim 9, said one or more retaining features disposed on said stem at an end of said shank distal from said head.

11. The weldless fuel fitting of claim 1, said flow paths comprising two or more flow paths.

12. A method of retro-fitting a gas tank for a return fuel line, comprising the steps of:
drilling a hole in said gas tank;
installing a fitting through said hole, said fitting comprising:
a head having a plurality of surfaces and two intersecting fluid flow paths therein;
a first surface of said plurality of surfaces having an aperture which extends into said head and defines one flow path of said two intersecting fluid flow paths;
a second aperture disposed a second surface of said head;
a second flow path of said two intersecting fluid flow paths disposed within said head;
a stem extending from said head and in fluid communication with said second flow path;
said stem having a shank that is deformable upon fastening of a fastener therein;
fastening said fastener in said stem within said gas tank;
deforming said shank by tightening of said fastener along an interior surface of said gas tank to seal said fitting to said gas tank.
